(19) United States
(12) Patent Application Publication
(10) Pub. No.: US 2004/0141263 A1
(43) Pub. Date: Jul. 22, 2004

(54) Surge-protecting printed circuit board layout

(76) Inventors: Robert R. Barger, Wichita, KS (US); David R. Ginskey, Wichita, KS (US)

Correspondence Address: SHOOK, HARDY & BACON LLP, 2555 GRAND BLVD, KANSAS CITY,, MO, 64108, US

(21) Appl. No.: 10/346,758

(22) Filed: Jan. 17, 2003

(51) Int. Cl. H02H 7/04

(52) U.S. Cl. 361/40

(57) ABSTRACT

Disclosed is a surge-protected layout for a printed circuit board useful for either through-hole or surface mount circuitry. A special arrangement of a ground trace on the board relative to the signal traces on the board reduces the damaging effects of over-voltage events to circuit components. More specifically, the arrangement is such that the ground trace is etched to encourage sparkover from the signal traces on the board by conforming parts of its perimeter to parts of the perimeters of the signal traces on the board. This has the effect of increasing the reliability of electrical and electronic circuitry, reducing repair and replacement costs of the same, and reducing equipment downtime due to over-voltage events. Additionally, the present invention is configured to tolerate a plurality of ‘hits’ from transient voltage surges and maintain its original functionality by making an edge portion of the ground trace and an edge portion of at least one signal trace define a gap therebetween, the gap having constant width along its length.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The present invention relates to printed circuit boards and, more particularly, to an improved method for printed circuit board layout for increased reliability and protection from transient over-voltage events.

2. Description of the Related Art

Printed circuit boards (PCBs) are normally manufactured by photographically reproducing an accurate positive or negative print of a circuit diagram, commonly referred to as a master, onto a copper covered insulation board, and removing, by chemical means, the unwanted copper.

Electronic systems are conventionally assembled on printed circuit boards (PCBs) that are designed for a particular application. Each board carries out a circuit function that is defined at the time that the board is designed. Certain limited adaptation may be possible by providing links or other variable devices, but the function of each board is virtually fixed.

To create the “master” from which the boards are produced, many PCB layout programs are available. Some programs can automatically take a circuit schematic created in compatible software and automatically render a PCB layout optimized based on selectable criteria (size, number of board layers, etc.). Others require the manual input of all circuit connections before the automatic layout process begins.

Due to the automation of the otherwise tedious layout process, a disconnect often occurs in industry between the design engineer and the final board layout. As evidence of this in the area of surge protection, from Chhawchharia et al., “Not much literature is available for the practicing engineers or novices as how the PCB layout affects the performance if the varistors are placed improperly inside the convertors or in the desktop transient suppression systems.”

While the productivity gain realized from the automatic board layout process is attractive to many businesses, significant opportunity costs exist. Among others, layout for ease of repair and testing, which requires direct input from the circuit designer and can not be predicted by the automatic layout process. Also, automatic layout often does not take into account the work the does exist, such as by Chhawchharia et al., which offers insight into the effect the physical layout of the board will have on surge suppression.

The telecommunications infrastructure, in particular, is especially vulnerable to voltage surges due to the exposure of telephone lines to the environment and their physical proximity to high voltage power lines. Lightning strikes and contact with power lines, known in the art as a power cross, can result in voltage levels experienced by equipment attached to the lines that is damaging to the connected equipment.

In the past, a great number of devices have been employed or invented to protect equipment attached to the telephone lines from damaging over-voltage conditions. An example of such a device was disclosed in U.S. Pat. No. 5,844,761 issued to Place, IV (“the '761”). The '761 discloses a device designed for a telecommunication line card lightning and power fault protection. It, like all other surge suppression techniques known to date, relies on the concept of adding components to a PCB to add protection. The added protective element in the '761 is a heat generating fusible resistive element attached to a spring tensioning device. When a voltage surge is encountered, the element melts and the spring aids in disconnecting the circuit. However, because it is an added feature to the line card, the cost of producing such a card is higher that if it were part of the PCB itself. Further, a fusible resistive element like the one disclosed in the '761 may only be used once, and then be replaced. Thus, there is a need in the art for a surge protection technique that uses the traced circuitry of the PCB itself to offer primary, intrinsic protection from over-voltage conditions, and that is effective for multiple overvoltage occurrences.

It is desirable to not only lay out the PCB components in such a fashion as to improve the effectiveness of surge suppressive components, but also to lay out the signal paths of specific traces in such a manner that a degree of surge suppression is offered by the PCB itself and not just by the components that populate it. It is additionally desirable for the solution to be both surface mount and through-hole compatible to meet a greater array of industry needs.

### SUMMARY OF THE INVENTION

The present invention overcomes the problems existent in the prior art by providing a surge-protected layout for a printed circuit board useful for either through-hole or surface mount circuitry. The arrangement of a ground traces relative to the signal traces on the board reduces the damaging effects of over-voltage events to circuit components.

More specifically, the arrangement is such that the ground trace is etched to encourage sparkover from the signal traces on the board by conforming parts of its perimeter to parts of the perimeters of the signal traces on the board. In some cases this is done by configuring the ground trace on the board to include a portion (or portions) that isolate the signal traces. This may be done by meanderingly interposing branches of the ground trace between the signal traces on the board. This may also be done by partially surrounding portions of the signal traces with portions of the ground trace. Thus configuring the ground traces increases the reliability of the electrical and electronic circuitry, reducing repair and replacement costs of the same, and reducing equipment downtime due to over-voltage events.

Another surge managing benefit provided by the present invention involves configuring an edge portion of the ground trace and an edge portion of at least one signal trace to define a gap therebetween, the gap having constant width along its length. This enables the ground trace to tolerate a plurality of ‘hits’ from transient voltage surges while maintaining its original surge dissipating functionality

### BRIEF DESCRIPTION OF THE DRAWING

The present invention is described in detail below with reference to the attached drawing figures, wherein:

FIG. 1 is an exemplary operating environment for the present invention

FIG. 2 an exemplary operating environment for an alternative embodiment of the present invention.

FIG. 3A is a depiction of the physical layout and trace routings of a section of a prior art printed circuit board;

FIG. 3B is a view of the layout of a section of a printed circuit board demonstrating the trace configuration principles of the present invention; and

FIG. 4 is a second printed circuit board layout demonstrating the trace configuration principles of the present invention.

### DETAILED DESCRIPTION OF THE INVENTION

The present invention provides a novel way to configure the traces on a printed circuit board (PCB) to provide primary surge protection in both through-hole and surface mount circuitry. Although additional printed circuit board (PCB) manual trace routing may be necessary, significant protection from over-voltage events is offered by the present invention at little or no additional manufacturing expense. Additionally, the trace configurations of the present invention enable the board to tolerate a plurality of ‘hits’ from transient voltage surges and maintain its original functionality, thus increasing the reliability of connected circuitry. Those of ordinary skill in the art of PCB layout will be able to make and use the invention according to the disclosure hereof.

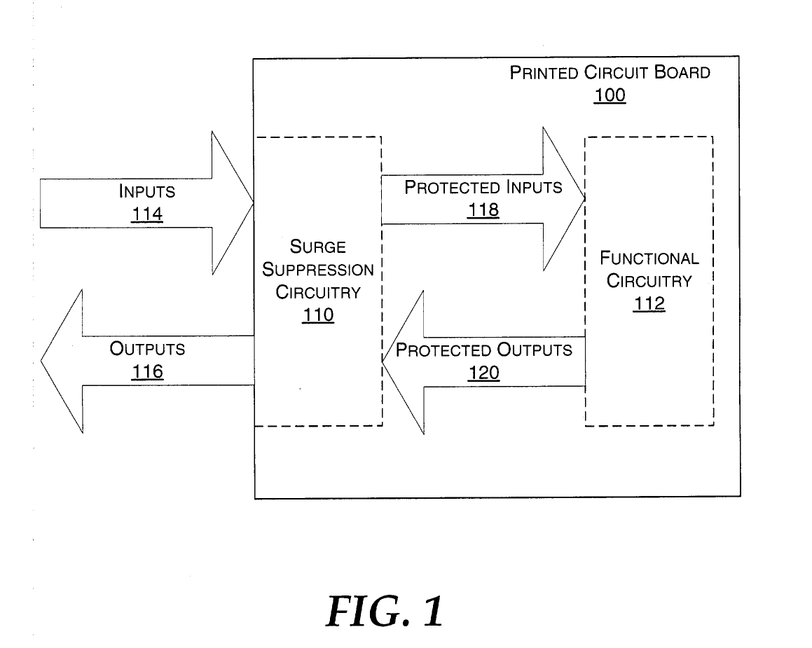

Referring to FIGS. 1-4, the present invention is implemented on printed circuit board (PCB) 100. Printed wiring board (PWB) is another common industry name for PCB 100. PCB 100 could be constructed of any circuit board fabrication material used in industry, including copper-clad FR4, polyamide, ceramic, and teflon. However, any acceptable material may be used, and the particular material selected is not critical to the invention.

PCB 100 comprises surge suppression circuitry 110 and functional circuitry 112. Surge suppression circuitry 110 protects functional circuitry 112 from over-voltage conditions introduced through the interface with the inputs 114 and the outputs 116. An over-voltage condition results from an over-voltage event such as a lightning strike, a power cross, inductive kickback, capacitor switching, power system instabilities and disturbances, and the like. Inputs 114 and outputs 116 represent any off-board connection, including connections to power sources, ground, antennas, signal sources, and external equipment. Functional circuitry 112, carries out circuit functions as appropriate for a specific application. Once the input signals 114 have passed through surge suppression circuitry 110, they become the protected inputs 118 and are connected to functional circuitry 112. The output signals in the “protected side” of surge suppression circuitry 110 are referred to as the protected outputs 120, which are connected to functional circuitry 112. External over-voltage events can occur on either inputs 114 or outputs 116, thus all external connections should be protected in order to prevent damage to functional circuitry 112.

The present invention resides within surge suppression circuitry 110, as will be described in detail later in the specification.

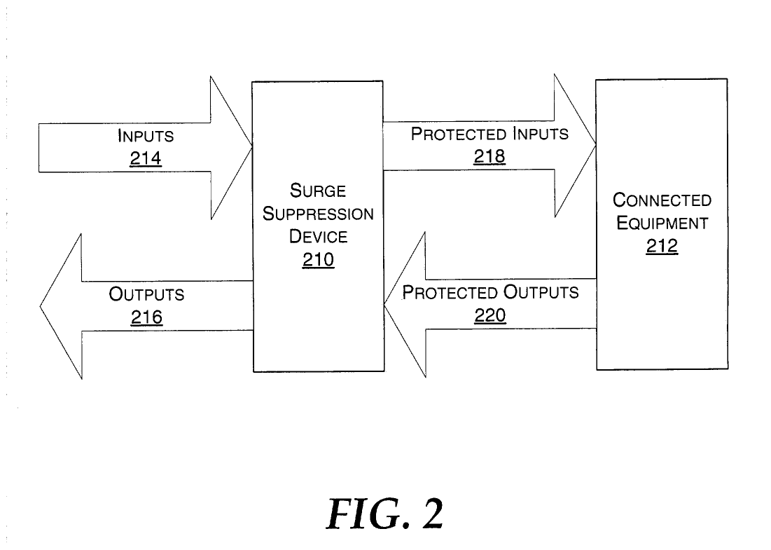

Referring now to FIG. 2, an exemplary operating environment for an alternate embodiment is depicted. The present invention is implemented in the surge suppression device 210. Surge suppression device 210 is interposed between connected equipment 212 and the connected equipment's external connections, which include inputs 214 and outputs, 216. Surge suppression device 210 absorbs energy from over-voltage events carried on inputs 214 and outputs 216 that could damage connected equipment 212. The present invention is implement on surge suppression device 210 in a manner that is fully disclosed later in the specification.

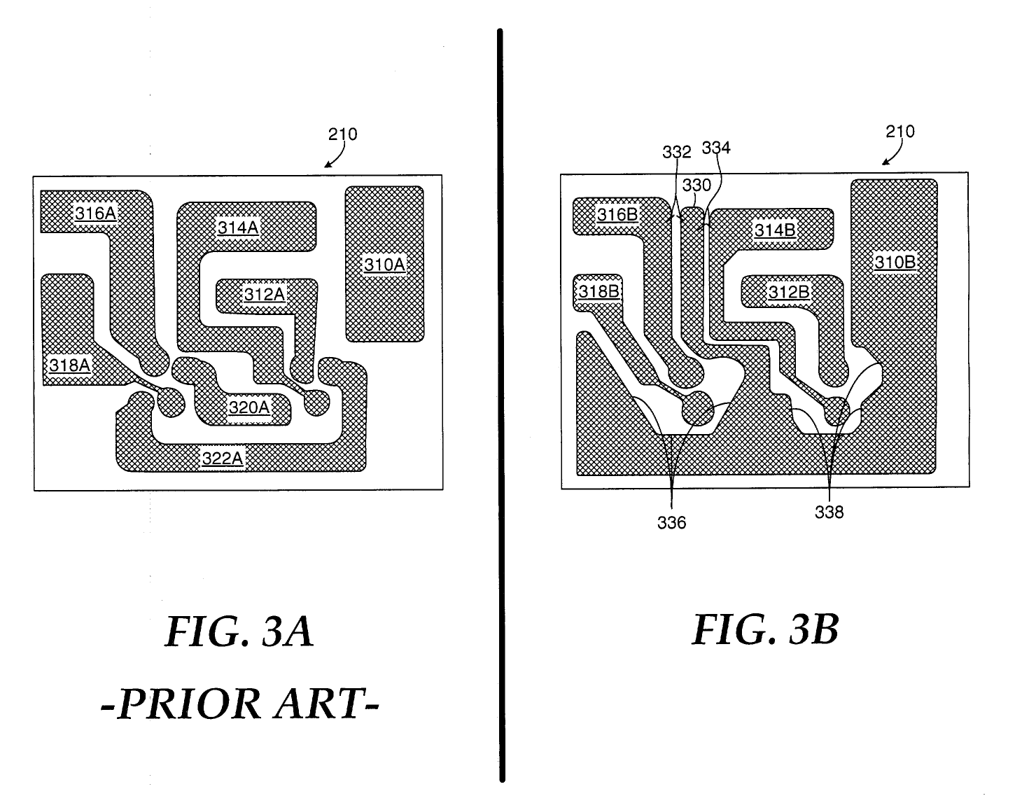

Turning now to FIGS. 3A and 3B, the present invention is compared and contrasted with the prior art. An exemplary artwork for surge suppression device 210 is shown. More specifically, the artwork shown is that for a device designed to protect telecommunications equipment from over-voltage conditions introduced through Plain Old Telephone System (POTS) lines. As will be evident to one of ordinary skill in the relevant art, the artwork shown could also be a subset of the artwork for PCB 100, wherein the artwork shown represents surge suppression circuitry 110.

FIG. 3A depicts the artwork for a surge suppression device 210 as can be found in the prior art. Trace 310A is a ground trace. The term ground generally implies earth ground, but as used herein, the definition also intended to include a signal ground, chassis ground, or any other ground as appropriate for a particular surge protection application.

As would be well understood by one of ordinary skill in the art, it is desirable that the “ground trace” of the present invention be electrically connected, and thus at nearly the same voltage potential, as the ground to which the expected surge waveform is referenced.

Traces 312A, 314A, 316A, and 318A are signal traces, wherein a signal trace means any intended conducting path other than trace 310A. Exemplary signals carried by a signal trace include analog signals, digital signals, data signals, alternating current (AC) and direct current (DC) power signals, and the like. Traces 320A and 322A are unused and unprotected traces. Traces 316A and the 318A are connected to the POTS in a correct installation of surge suppression device 210 and traces 312A and 314A are the protected signals connected to the telecommunications equipment. If an over-voltage condition occurs between the ground trace, 310A and any of the signal traces 312A-318A, the potential would exist for the voltage carried by a signal trace to exceed the breakdown threshold of the solder resist PCB coating and air. A flash-over could occur between several voltage signals and ground. Even the presence of so-called voltage-limiting devices such as metal-oxide varistors (MOVs), spark-gap arrestors, transorbs, and zener diodes is no guarantee of a successful surge suppression in the presence of large surge currents. Surge protection circuitry and associated protected circuitry are routinely vaporized by the high-energy, over-voltage condition created by a nearby lightning strike. Thus, a high-voltage surge from a low impedance source on signal trace 318A could follow the following path on its way to the ground trace, 310A: trace 318A flash-over to trace 320A, run the length of trace 320A, flash-over to trace 314A, flash-over to trace 312A, and then flash-over to ground trace 310A. Lab testing results support the given theoretical scenario. Thus, an especially severe over-voltage event could, via the given flashovers, reach the connected, “protected” telecommunications equipment with enough energy to damage to functional circuitry of virtually all the equipment associated with that particular PCB.

The present invention, as implemented in FIG. 3B, greatly reduces or eliminates the possibility of flash-over between signal traces by configuring a significant portion of the ground trace perimeter to conform to the signal trace perimeters. This encourages breakover from said at least one of said signal trace perimeters onto said ground trace. This trace layout strategy may be seen in the figure. By locating a ground trace 310B within close proximity to the signal traces 312B, 314B, 316B, and 318B, breakover is encouraged, as is desirable when the goal is surge protection. Traces 320A and 322A have been discarded and have no equivalent in FIG. 3B. In addition to locating ground trace 310B near the signal traces, ground trace 310B also physically separates the unprotected signal paths, 316B and 318B, from the protected signal paths, 312B and 314B, with a ground trace branch 330. As can be seen from the figure, branch 330 is interposed between traces 314B and 316B. Of additional interest are edge pair 332 and edge pair 334. It is well understood in the art that sharp angles and edges promote flash-over points. However, in the event of a sustained over-current condition, the jagged edges can quickly become vaporized (like a fuse) and thus quench the flash-over arc. Thus edge pairs 332 and 334 are largely equidistant along their length in order to provide surfaces suitable to handle large and sustained flash-over currents. The term “sustained,” as used here does not necessarily imply steady-state, rather it refers to a duration of time longer than the duration of common transient surge events.

As one skilled in the relevant art would appreciate, the flash-over voltage threshold for a given edge pair is directly related to the distance between the edges. As shown in FIG. 3B, edge pair 334 would have a lower flash-over voltage threshold than edge-pair 332. Thus, another aspect of the present invention is revealed in that the distance between edge pairs can be selected based on the associated circuitry and the overall approach to surge suppression employed by the designer of surge suppression device 210. For instance, the distance between edge pairs may vary depending on whether the edge pair is associated with the primary stage of suppression, secondary stage of suppression, etc.

In the lower half of ground trace 310B, a different ground trace configuring strategy of the present invention is revealed. As may be seen in FIG. 3B, the lower portions of signal traces 316B and 318B are partially surrounded by the inside perimeter 336 of ground trace 310B. Similarly, the lower portions of traces 312B and 314B are partially surrounded by an inside perimeter 338 of ground trace 310B. By surrounding these lower portions of signal traces 312B, 314B, 316B, and 318B with ground trace 310B, surge protection is further enhanced.

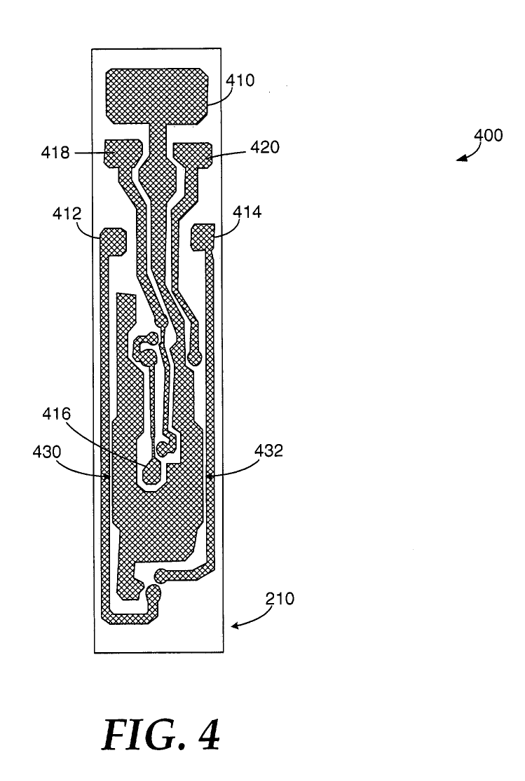

Turning now to FIG. 4, the inventors disclose another embodiment 400 of the present invention. Several aspects of the previous invention are again present in the artwork for a surge suppression device 210, which comprises a ground trace 410, and several signal traces, including signal trace 412 and signal trace 414. Again, as will be evident to one of ordinary skill in the relevant art, the artwork shown could also be a subset of the artwork for PCB 100, wherein the artwork shown represents surge suppression circuitry 110. Of notable interest of embodiment 400 is the way in which ground trace 410 comes within close proximity to all other traces on the PCB, and conforms (where possible) to the perimeter of these signal traces. In order to accomplish the overall goals of: (i) remaining in close proximity of the signal trace perimeters, and (ii) generally conforming the perimeter of the ground trace to the adjacent perimeter of the signal traces, ground trace 410 is disposed on the board so as to meanderingly interpose itself between numerous signal traces (412, 414, 418, and 420) on the board. Additionally, the same “partially-surrounding”strategy revealed in FIG. 3B, may be seen here as well. For example, the lower portions of signal trace 418 and almost all of trace 416 are surrounded by ground trace 410.

Taking an even closer look at trace 416 is further exemplary in terms of showing the goals of the present invention. Signal trace 416 has an odd-shaped pad at its lower end. This pad is encircled by ground trace 410 leaving only a substantially equidistant gap. All the principles of the present invention applied to the parallel edge pairs examined above are also valid for the edge pair formed by ground trace 410 and signal trace 416.

Other edge pair configurations are also contemplated by the present invention. In fact, any trace contour that can be duplicated or nearly duplicated either by hand or by PCB layout software is within the scope of the present invention. For instance, had the pad of signal trace 416 been a circle rather than an irregular polygon, ground trace 410 could be arranged to partially encircle the pad to form an edge pair with a gap that is substantially equidistant.

The concept of using a portion of the ground perimeter and a portion of a signal trace perimeter to define therebetween a substantially non-conductive gap which has a uniform width along at least a portion of its length, may be seen by referring to edge pairs 430 and 432. Edge pairs 430 and 432 depict parallel edge pairs which are close enough together to encourage spark-over in overvoltage situations, but far enough apart to prevent breakover by normal operating voltages. Because the gap between edge pairs 430 and 432 is largely equidistant along its length, the circuit is able to handle large and sustained flash-over currents. This is because pairs 430 and 432 provide a substantial possible spark-over area. Just because a spark over may destroy a portion of pairs 430 and 432, there will still be a significant amount of the perimeters of 430 and 432 remaining for additional spark-overs.

Although the artworks shown in FIGS. 3B and 4 are related to protecting telecommunications equipment, these are meant to be exemplary in nature and in no way limiting. As will be appreciated by one of ordinary skill in the relevant arts of electronic design, electrical design, and PCB layout, the present invention can be implemented in the artwork of any design for which protection from over-voltage events is desirable. The principles of the present invention lend themselves well to both surface mount and through-hole designs. In addition, the principles of the present invention can be applied to single-sided, double-sided, and multilayer printed circuit boards.

As can be seen, the present invention and its equivalents are well adapted to provide protection to connected circuitry from over-voltage conditions. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled artisan may develop alternative systems or methods while maintaining one of the several objectives of the invention, which are not limited to reducing the damaging effects of over-voltage events through the special arrangement of PCB traces, thereby increasing the reliability of electrical and electronic circuitry, reducing repair and replacement costs of the same, and reducing equipment downtime due to said over-voltage events.

It will be understood that certain features and subcombinations are of utility and may be employed without reference to other features and subcombinations and are contemplated within the scope of the claims. Not all steps listed in the various figures need be carried out in the specific order described.

What the invention claimed is:

1. A surge-protecting printed circuit board, comprising:
a first trace included within a first perimeter;
a ground trace included within a ground trace perimeter; and
a portion of said first perimeter and a portion of said ground trace perimeter defining therebetween a first substantially non-conductive gap;
said first gap being of a uniform width along at least a portion of its length, said width being small enough to encourage spark-over in overvoltage situations, but large enough to prevent breakover by normal operating voltages.

2. The printed circuit board of claim 1 wherein said portion of said first perimeter and said portion of said ground trace perimeter run parallel, one to the other.

3. The printed circuit board of claim 1 wherein said portion of said first perimeter and said portion of said ground trace perimeter are curved.

4. The printed circuit board of claim 1 further comprising:
a second trace included within a second perimeter; and
a portion of said second perimeter and a second portion of said ground trace perimeter defining therebetween a second substantially non-conductive gap;
said second gap being of uniform width along at least a portion of its length.

5. The printed circuit board of claim 4 wherein said portion of said second trace perimeter and said second portion of said ground trace perimeter run parallel, one to the other.

6. The printed circuit board of claim 4 wherein said portion of said second trace perimeter and said second portion of said ground trace perimeter are curved.

7. A surge-protecting printed circuit board, comprising:
a plurality of signal trace elements, each of said signal trace elements having a perimeter;
a ground trace having a perimeter; and
a significant portion of said ground trace perimeter configured to conform to at least one of said signal trace perimeters for the purpose of encouraging breakover from said at least one of said signal trace perimeters onto said ground trace.

8. The printed circuit board of claim 7 wherein said ground trace is configured to include an isolating portion that isolates a portion of said at least one signal trace from a portion of at least one other signal trace.

9. The printed circuit board of claim 8 wherein said isolating portion is a branch off said ground trace interposed between said portion of at least one signal trace and said portion of at least one other signal trace.

10. The printed circuit board of claim 7 wherein said ground trace is configured to include a partially surrounding portion which surrounds a portion of at least one signal trace.

11. The printed circuit board of claim 7 wherein said ground trace is meanderingly interposed between said portion of at least one signal trace and said portion of at least one other signal trace.

12. A method of producing a surge-protected printed circuit board comprising the steps of:
providing a substrate;
forming at least one signal trace on said substrate;
forming a ground trace on said substrate;
configuring said at least one signal trace and said ground trace on said substrate such that a portion of said at least one first trace and a portion of said ground trace define therebetween a substantially non-conductive gap; and
further defining said first gap so as to be of uniform width along at least a portion of its length, said width being small enough to encourage spark-over in overvoltage situations, but large enough to prevent breakover by normal operating voltages.

13. The method of claim 12 including the additional step of:
configuring a portion of said ground trace to include an isolating portion that isolates a portion of said at least one signal trace from a portion of at least one other signal trace.

14. The method of claim 13 including the additional step of creating said isolating portion by branching it off from said ground trace so as to be interposed between said portion of at least one signal trace and a portion of at least one other signal trace.

15. The method of claim 12 including the additional step of partially surrounding a portion of said at least one signal trace with a portion of said ground trace.

16. The method of claim 12 including the additional step of meanderingly interposing said ground trace between a portion of said at least one signal trace and a portion of at least one other signal trace.
